(19) United States
(12) Patent Application Publication
(10) Pub. No.: US 2020/0130261 A1
(43) Pub. Date: Apr. 30, 2020

(54) SHAPE-SHIFTING STRUCTURED LATTICE AND METHOD OF MAKING A SHAPE-SHIFTING STRUCTURED LATTICE

(71) Applicants: President and Fellows of Harvard College, Cambridge, MA (US); Massachusetts Institute of Technology, Cambridge, MA (US)

(72) Inventors: Jennifer A. Lewis, Cambridge, MA (US); Lakshminarayanan Mahadevan, Cambridge, MA (US); J. William Boley, Cambridge, MA (US); Willem M. van Rees, Cambridge, MA (US)

(73) Assignees: President and Fellows of Harvard College, Cambridge, MA (US); Massachusetts Institute of Technology, Cambridge, MA (US)

(21) Appl. No.: 16/661,815

(22) Filed: Oct. 23, 2019

Related U.S. Application Data
(60) Provisional application No. 62/749,846, filed on Oct. 24, 2018.

(51) Int. Cl. B29C 64/118; B29C 64/209

(52) U.S. Cl. CPC B29C 64/118; B33Y 10/00; B29C 64/209

(57) ABSTRACT

A shape-shifting structured lattice comprises a printed lattice including printed ribs joined at nodes. Each printed rib has a predetermined sweep angle \tilde{θ}ᵢ between adjacent nodes and a bilayer structure including at least two printed filaments in contact along a length thereof. The at least two printed filaments comprise different linear coefficients of thermal expansion and/or different values of elastic modulus. When exposed to a stimulus, the printed lattice adopts a predetermined three-dimensional geometry.

### RELATED APPLICATIONS

The present patent document claims the benefit of priority to U.S. Provisional Patent Application No. 62/749,846, which was filed on Oct. 24, 2018, and is hereby incorporated by reference in its entirety.

### FEDERALLY SPONSORED RESEARCH OR DEVELOPMENT

This invention was made with government support under grant numbers DMR-1420570 (Harvard MRSEC), 15-33985 (NSF DMREF), and SC001-0000000957 (Charles Stark Draper Laboratory, Inc.) awarded by the National Science Foundation. The government has certain rights in the invention.

### TECHNICAL FIELD

This disclosure is related generally to direct ink writing or 3D printing, and more specifically to shape-shifting structures formed from printed filaments.

### BACKGROUND

Shape-morphing structured materials may have myriad applications in deployable systems, dynamic optics, soft robotics, and medicine, for example. The programming of material shape in three dimensions may require control over the metric tensor at every point in space and time, thus defining how lengths and angles change everywhere. For thin sheets, with in-plane dimensions that are much larger than the thickness, this may be considered to be mathematically equivalent to specifying the first and second fundamental forms of a middle surface that describe how material points deform in the tangent plane and how the middle surface is embedded in three dimensions, allowing for control of both the intrinsic (Gauss) and extrinsic (mean) curvature of the resulting surface. From a physical perspective, this may entail the design of material systems that can expand or contract in response to stimuli such as temperature, humidity, pH, etc., with the capacity to generate and control large in-plane growth gradients combined with differential growth through-thickness, which has thus far proven to be a significant challenge.

### BRIEF SUMMARY

A shape-shifting structured lattice comprises a printed lattice including printed ribs joined at nodes. Each printed rib has a predetermined sweep angle \tilde{θ}ᵢ between adjacent nodes and a bilayer structure including at least two printed filaments in contact along a length thereof. The at least two printed filaments comprise different linear coefficients of thermal expansion and/or different values of elastic modulus. When exposed to a stimulus, the printed lattice adopts a predetermined three-dimensional geometry.

A method of fabricating a shape-shifting structured lattice comprises: conformally mapping a three-dimensional geometry onto a plane to create a planar projection; discretizing the planar projection to create a grid comprising ribs joined at nodes; computing a requisite growth factor based on the three-dimensional geometry and determining a corresponding sweep angle \tilde{θ}ᵢ between adjacent nodes for each rib, thereby defining a planar print path; depositing filaments along the planar print path to form a printed lattice comprising printed ribs joined at the nodes, each printed rib having the sweep angle \tilde{θ}ᵢ and a bilayer structure including at least two printed filaments in contact along a length thereof, the at least two printed filaments comprising different ink compositions; curing the different ink compositions; and after the curing, exposing the printed lattice to a stimulus, thereby inducing the printed lattice to adopt the three-dimensional geometry.

### BRIEF DESCRIPTION OF THE DRAWINGS

FIG. 1A is a schematic of an exemplary shape-shifting structured lattice comprising a printed lattice in an initial printed configuration.

FIG. 1B shows a close-up view of part of the printed lattice of FIG. 1A.

FIG. 1C shows the three-dimensional geometry adopted by the printed lattice of FIG. 1A upon exposure to a stimulus, such as a change in temperature.

FIG. 2A is a schematic of an exemplary direct ink writing process to fabricate a shape-shifting structured lattice.

FIG. 2B is a plot showing an exemplary alignment probability density from a portion of a printed filament including anisotropic filler particles.

FIGS. 3A and 3B show the relationship between the crosslinker-to-base (“x-link: base”) weight ratio of ink compositions on the coefficient of thermal expansion and the elastic modulus of printed filaments.

FIG. 4A shows a printed lattice where the printed ribs have a multiplex bilayer structure comprising a two-by-two stack of four printed filaments, where each filament has a different material composition.

FIG. 4B illustrates how the out-of-plane curvature of a printed rib may be changed by flipping/transposing the material combinations within the multiplex bilayer structure.

FIG. 5 shows a portion of the printed lattice including a notch to aid in shape transformation.

FIGS. 6A-6E illustrate a method of fabricating a shape-shifting structured lattice.

FIG. 7A illustrates key parameters of an exemplary bilayer structure.

FIG. 7B shows experimental curvature of a thermally-cycled bilayer structure as a function of cycle number.

### DETAILED DESCRIPTION

A combination of multiple materials and geometry is employed to design a shape-shifting structured lattice that can morph into a predetermined three-dimensional geometry when exposed to a stimulus such as heat. The structured lattice may be formed from printed filaments comprising flow-aligned anisotropic filler particles in polymeric matrices with predetermined crosslink densities. The flow alignment of the anisotropic filler particles may be imparted by extrusion of a precursor ink during direct ink writing of the printed filaments, as described below.

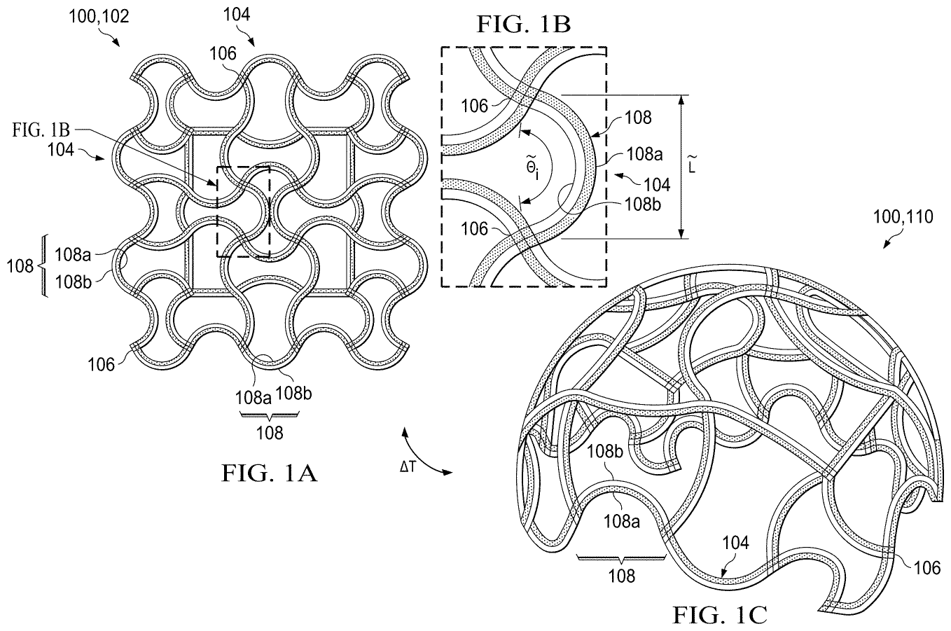

FIG. 1A shows an exemplary shape-shifting structured lattice 100 comprising a printed lattice 102 including printed ribs 104 joined at nodes 106. Each printed rib 104 has a predetermined sweep angle \tilde{θ}ᵢ between adjacent nodes 106 and a bilayer structure 108 including at least two printed filaments 108a,108b in contact along a length thereof, as shown in FIG. 1B. The printed lattice 102 may be homogeneous, with the same sweep angle \tilde{θ} for each printed rib, or heterogeneous as shown in FIG. 1A, with a sweep angle \tilde{θ}ᵢ that may be different for each printed rib 104. (The subscript i denotes a positive integer from 1 to n, where n may be equal to the number of printed ribs 104 in the printed lattice 102). This configuration, as shown in FIG. 1A for an exemplary printed lattice 102, may be described as an initial printed configuration.

The printed filaments 108a,108b may comprise different linear coefficients of thermal expansion and/or different values of elastic modulus, such that, when exposed to a stimulus, the printed lattice 102 exhibits a shape transformation and adopts a predetermined three-dimensional geometry 110, as illustrated in FIG. 1C. The stimulus can be a change in temperature (ΔT), a change in pH, a change in humidity, a change in pressure, application of a magnetic field, and/or application of an electric field. The printed lattice 102 may be able to reversibly shift between the predetermined three-dimensional geometry 110 and the initial printed configuration. The shape transformation may occur rapidly, e.g., in less than one second, and in some cases within ˜70 ms. While the printed lattice 102 shown in FIG. 1A comprises a two-dimensional lattice, in other examples the printed lattice 102 may comprise a one-dimensional or a three-dimensional lattice prior to the shape transformation.

Each of the printed filaments 108a,108b comprises a polymer, such as a thermosetting polymer that undergoes a crosslinking process upon curing. The thermosetting polymer may be an elastomer such as silicone (e.g., poly(dimethylsiloxane) (PDMS)) in one example. At least one of the printed filaments 108a,108b may include anisotropic filler particles, in which case the polymer referred to above may function as a polymer matrix. The anisotropic filler particles may have a long axis aligned with the print direction, as discussed below, which may help to reduce thermal expansion of the printed filament(s). The anisotropic filler particles may take the form of glass fibers, oxide fibers, carbon fibers, and/or other suitable fibers. Typically, the anisotropic filler particles may have a length in a range from about 100 microns to 500 microns and a width or diameter in a range from about 1 micron to about 30 microns. The printed filaments 108a,108b may further include other particulate additives, such as metal oxide particles (e.g., silica) or clay particles, which may be incorporated into the precursor ink to impart rheological properties suitable for direct ink writing. The other particulate additives may have a nanoscale particle size, such as a width or diameter in a range from about 5 nm to about 30 nm, or from about 7 nm to about 25 nm. The printed filaments 108a,108b may have a diameter or width in a range from about 10 microns to about 1,000 microns (1 mm), and more typically from about 50 microns to about 500 microns.

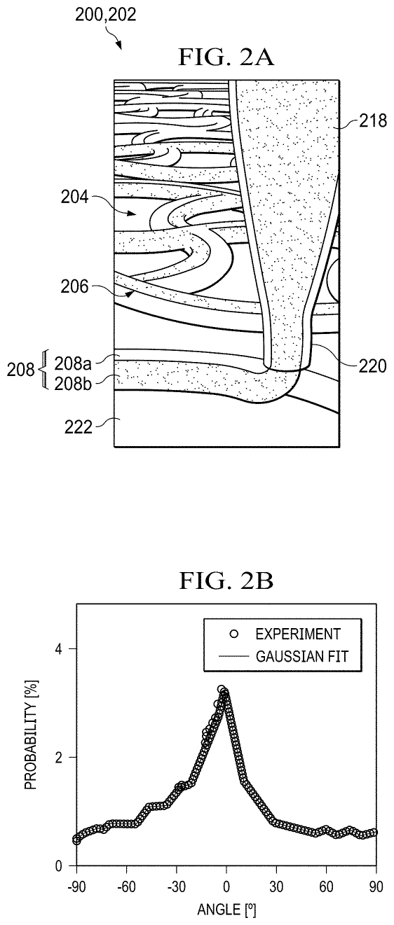

FIG. 2A is a schematic of an exemplary direct ink writing process, which may be referred to as 3D (or 4D) printing or direct write fabrication, to fabricate a shape-shifting structured lattice 200. Precursor inks 218 that are suitable for direct ink writing can be readily extruded through a deposition nozzle 220 to form an extruded filament that maintains its shape once deposited as a printed filament 208b. Suitable precursor inks 218 may be viscoelastic, with a strain-rate dependent viscosity. As shown in FIG. 2A, the printed filament 208b may have a sufficient stiffness to retain its shape and dimensions on the substrate 222. Two filaments 20a,208b can be printed on the substrate in a predetermined 2D or 3D pattern, as shown, to form a printed lattice 202 including printed ribs 204 joined at nodes 206, where each printed rib 204 has a predetermined sweep angle \tilde{θ}ᵢ between adjacent nodes 206 and a bilayer structure 208. Anisotropic filler particles included in the precursor ink 218 may have a long axis aligned with the print direction (e.g., longitudinally aligned within +/−20°, or within +/−10°, of the print direction) due to the extrusion process. FIG. 2B shows an exemplary alignment probability density from a portion of a printed filament 208b including anisotropic filler particles. The data indicate strong alignment along the print direction. The substrate 222 is typically a solid, but direct ink writing may alternatively be carried out using a gel or viscous liquid as a substrate. During printing, the deposition nozzle 220 can be moved at a constant or variable print speed while the substrate 222 remains stationary. Alternatively, the substrate 222 may be moved while the deposition nozzle 220 remains stationary, or both the deposition nozzle 220 and the substrate 222 may be moved. The printed filaments 208a,208b may be heated or otherwise processed after extrusion and/or deposition to cure the precursor ink 218, thereby increasing the stiffness of the printed filaments 208a,208b.

Preferably, to ensure that the printed filaments 208a,208b exhibit different linear coefficients of thermal expansion and/or different values of elastic modulus, the printed filaments 208a,208b may be extruded from different precursor inks (“ink compositions”). The ink compositions may be prepared from different uncured (base) polymers and/or different crosslinker-to-base ratios such that the printed filaments 208a,208b comprise different polymer matrices and/or different crosslink densities upon curing. The crosslinker-to-base ratio may lie in a range from about 1:5 to about 1:100, or from about 1:10 to about 1:50. Depending on the ink composition, curing may be effected by exposure to heat, light, and/or a chemical curing agent. Generally speaking, after curing, the printed filaments 208a,208b comprise different linear coefficients of thermal expansion and/or different values of elastic modulus.

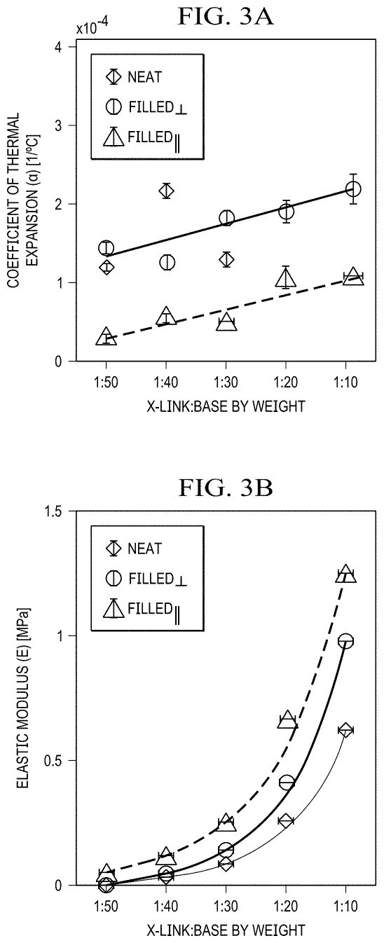

In some examples, it may be beneficial to select the same uncured polymer for the different ink compositions while varying the crosslinker-to-base ratio. FIGS. 3A and 3B show the relationship between crosslinker-to-base ratio (by weight) on the coefficient of thermal expansion and the elastic modulus of printed filaments referred to as “neat,” “filled_{⊥},” and “filled_{∥},” which represent, respectively, printed filaments that do not contain anisotropic filler particles, printed filaments containing non-aligned anisotropic filler particles (⊥; perpendicular to print direction), and printed filaments containing aligned anisotropic filler particles (∥; aligned with the print direction). In the examples of FIGS. 3A and 3B, the polymer matrix comprises PDMS and the anisotropic filler particles comprise glass fibers in an amount of 20 wt. %; the printed filaments further comprise fumed silica particles in an amount of 20 wt. %

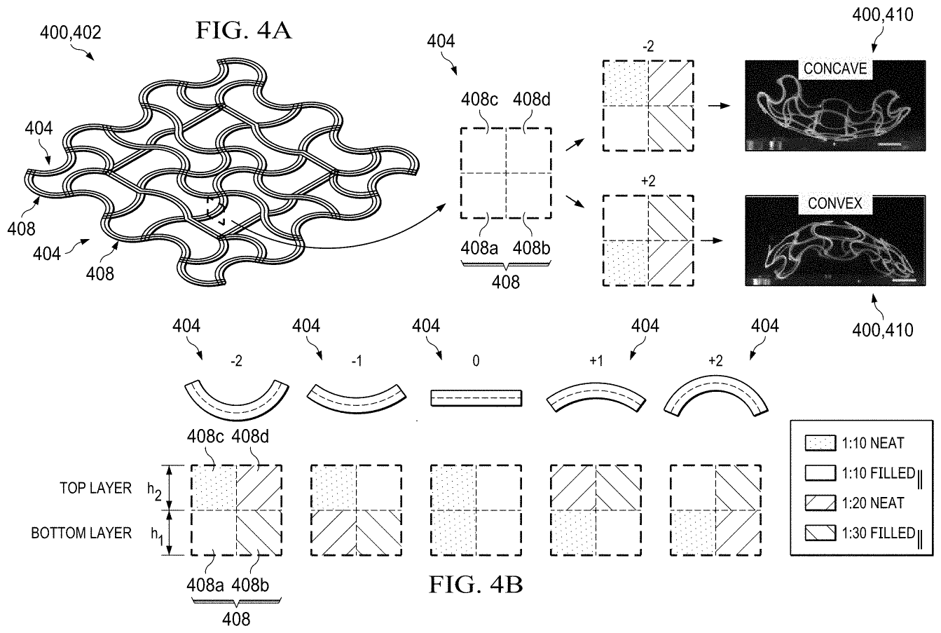

As shown in FIGS. 1A-1C, each printed rib 104 may comprise two printed filaments 108a,108b. In some examples, each printed rib may comprise four printed filaments. To fully control 3D shape, it is desirable to program both intrinsic curvature and extrinsic curvature. To achieve this, the bilayer structure 408 of the printed ribs 404 may be a multiplex bilayer structure comprising a two-by-two stack of the four printed filaments 408a,408b,408c,408d, as shown in FIGS. 4A and 4B. Since each printed filament may comprise a different material, four different materials may be used in the cross-section of each printed rib 404, allowing for control of expansion across the thickness and width thereof according to the Timoshenko equation given below. Normal curvature can be directed up or down by interchanging the top and bottom layers and the magnitude can be discretely controlled by transposing the materials in the cross-section, as illustrated in FIGS. 4A and 4B. A concave three-dimensional geometry 410 may be obtained based on one four-material combination, while a convex three-dimensional geometry 410 may be obtained based on another. It can be appreciated that a printed lattice 402 comprising a multiplex bilayer structure 408 yields a shape-shifting structured lattice 400 with several unique features. First, these printed lattices 402 exhibit a substantial amount of local linear in-plane growth (e.g., 40% growth to 79% contraction as currently demonstrated; 57% growth to 100% contraction in theory), which can be independently varied across the lattice 402 as well as in each of the two orthogonal directions of the lattice 402. This capability can be generalized to lattices of different scales, materials, and/or stimuli. Second, the out-of-plane bending control reduces elastic frustration, which simplifies their inverse design and expands the range of shapes that can be achieved.

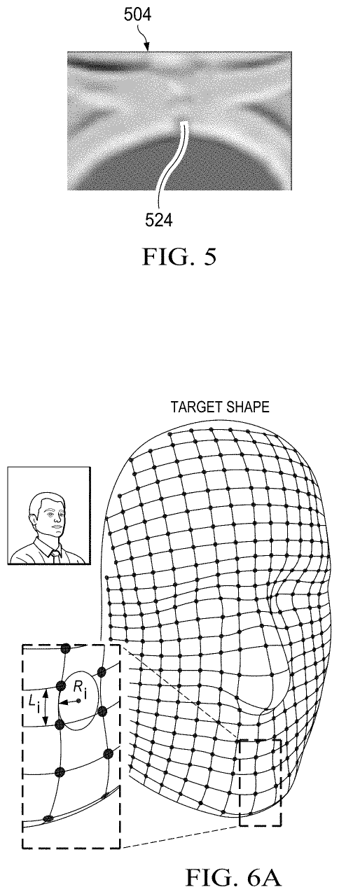

In some examples, such as that shown in FIG. 5, part of the printed lattice, e.g., one or more of the printed ribs 504, may further comprise a notch 524 to facilitate the shape transformation. The notch may be particularly useful with a bilayer structure comprising (just) two printed filaments.

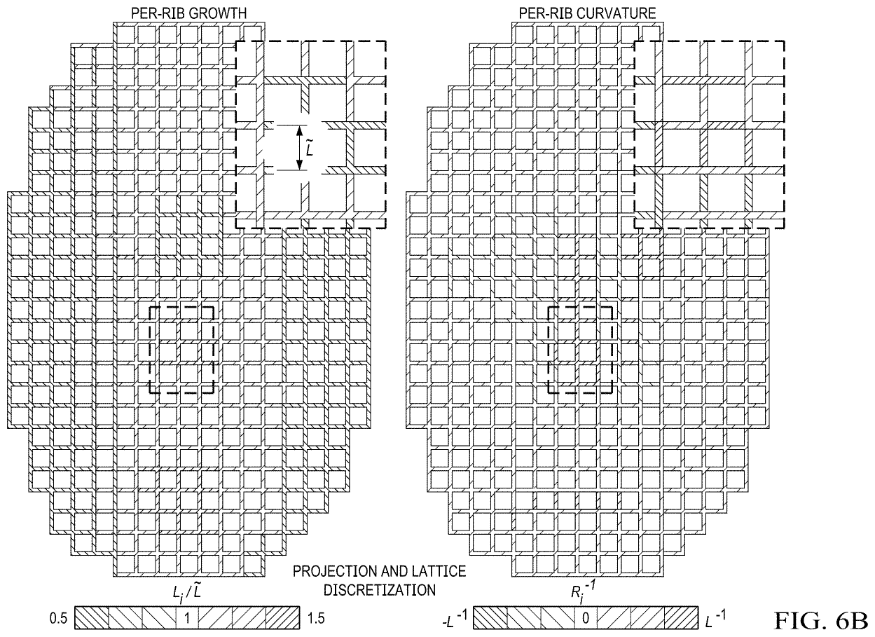

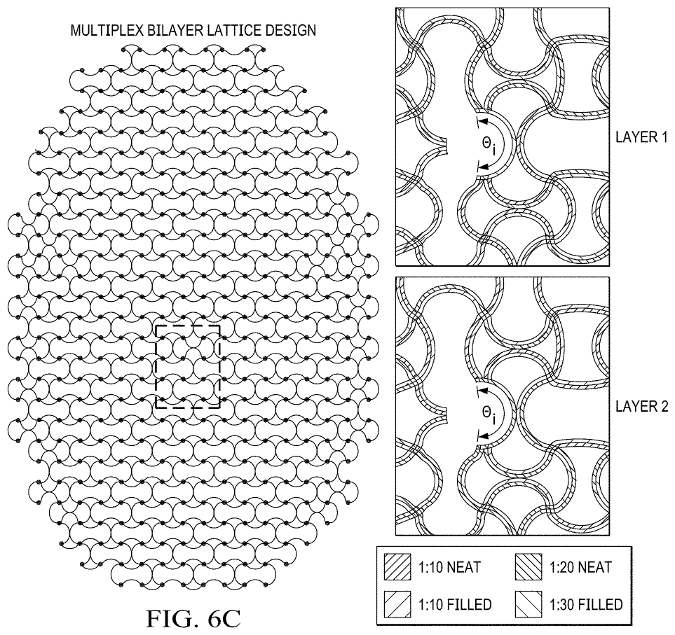

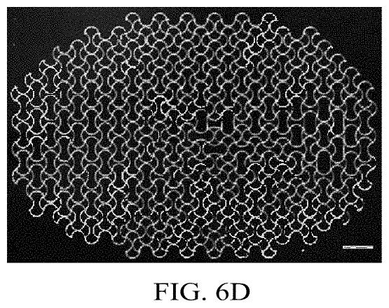

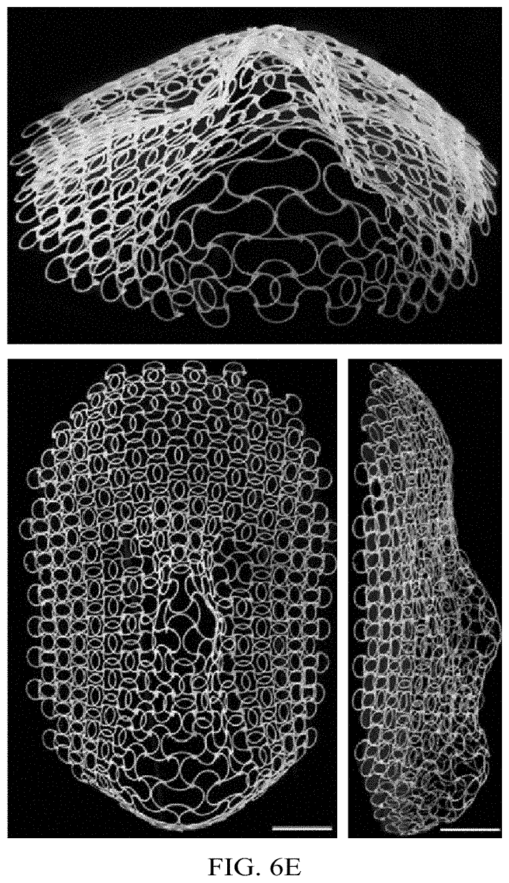

Referring now to FIGS. 6A-6E, a method of fabricating a shape-shifting structured lattice is described. The method includes mapping or conformally mapping a three-dimensional geometry (in this example, a three-dimensional face as shown in FIG. 6A) onto a plane to create a planar projection, as shown in FIG. 6B, and then discretizing the projection to create a grid comprising ribs joined at nodes. The grid may comprise square cells, or non-square polygonal cells. The grid may be a one-dimensional or a two-dimensional grid (as shown).

Referring to FIG. 6C, a requisite growth factor is computed based on the three-dimensional geometry and a corresponding sweep angle \tilde{θ}ᵢ is determined between adjacent nodes for each rib to define a print path, which is typically a planar print path. FIG. 6C shows an exemplary design of the printed lattice and each layer of the bilayer structure. In this example, the printed lattice has an arbitrary shape including Nₓ cells along an x-direction and N_{y} cells along a y-direction. Generally speaking, the printed lattice may be a one-dimensional, a two-dimensional, or a three-dimensional lattice.

Filaments are deposited along the planar print path to form a printed lattice, as shown in FIG. 6D, which comprises printed ribs joined at nodes, where each printed rib has the sweep angle \tilde{θ}ᵢ and a bilayer structure including at least two printed filaments in contact along a length thereof. As illustrated in FIG. 2, prior to depositing the filaments, each filament may be extruded from a deposition nozzle. The at least two printed filaments (referred to as “the printed filaments” below) may comprise different ink compositions, as discussed above. The different ink compositions undergo curing, typically after deposition of the printed filaments, by exposure to heat, light, and/or a chemical curing agent. Upon curing, the printed filaments may comprise different linear coefficients of thermal expansion and/or different values of elastic modulus. The different ink compositions and the printed filaments may have any of the characteristics described in this disclosure. Each printed rib may comprise only two printed filaments, as shown in FIGS. 1A-1C. In another example, each printed rib may comprise four printed filaments arranged in a two-by-two stack, such that the bilayer structure is a multiplex bilayer structure as described above in reference to FIGS. 4A and 4B. In some examples, each printed rib may further comprise a notch, as illustrated in FIG. 5.

The printed lattice may then be exposed to a stimulus (e.g., a change in temperature, a change in pH, a change in humidity, a change in pressure, application of a magnetic field, and/or application of an electric field), which induces the printed lattice to adopt the three-dimensional geometry, as shown in FIG. 6E. As indicated above, the printed lattice can reversibly shift between the three-dimensional geometry and an initial printed configuration.

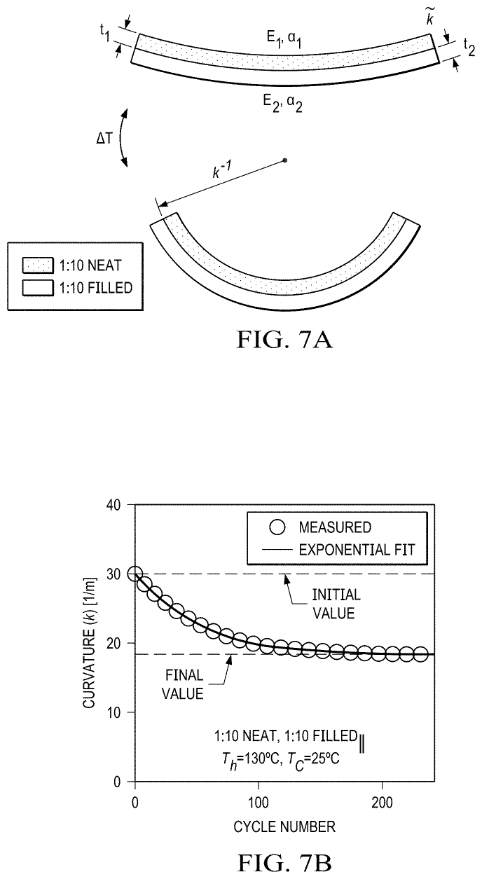

Key parameters of the bilayer structure, the basic functional unit of the shape-shifting structured lattices, are illustrated in FIG. 7A. These key parameters include initial curvature (\tilde{κ}), layer thicknesses (t₁ and t₂), linear αs (α₁ and α₂), elastic moduli (E₁ and E₂) of the high and low α layers, where 1 represents the low α material and 2 represents the high α material), imposed temperature difference (ΔT<0), and final curvature (κ) under applied temperature difference. The curvature response of such bilayer structures to a temperature change (ΔT) can be expressed using the Timoshenko equation:

$$\frac{δ κ {t}_{2}}{Δ T} = ( {α}_{2} - {α}_{1} ) \frac{6 β γ ( 1 + β )}{1 + 4 β γ + 6 {β}^{2} γ + 4 {β}^{3} γ + {β}^{4} {γ}^{2}} \qquad ( 1 )$$

where δκ=κ−\tilde{θ} is the change in curvature after ΔT, \tilde{θ} is the curvature of the bilayer before ΔT, κ is the curvature after ΔT, t is the layer thickness, β=t₁=t₂, γ=E₁=E₂, and subscripts 1 and 2 denote the low and high α materials, respectively. FIG. 7B shows experimental curvature of a thermally cycled bilayer structure as a function of cycle number. The curvature change of the experimental bilayer structures is reversible and repeatable; however, to allow for complex 3D shape changes, these bilayer structures are arranged into a lattice as set forth above, where a linear growth factor s=L/\tilde{L} of each printed rib can be expressed by the following equation:

$$s = \frac{L}{\tilde{L}} = \frac{2 sin ( \frac{1}{4} \tilde{θ} ( 2 + \frac{\tilde{L} δ κ}{sin ( \tilde{θ} / 2 )} ) )}{2 sin ( \tilde{θ} / 2 ) + \tilde{L} δ κ} \qquad ( 2 )$$

As in the simple bilayer case, the structured lattices can undergo repeated expansion and contraction in response to a stimulus, such as a change in temperature. The lattice may be homogeneous or heterogeneous, where, in the latter case, the initial sweep angle of each rib is considered an independent degree of freedom and is therefore indexed within the lattice, e.g., \tilde{θ}ᵢ as opposed to \tilde{θ} in the homogeneous case. From a conformal map of the desired target shape to the plane, it is possible to compute the required growth factor for each rib and invert equation (2) to find the corresponding value of \tilde{θ}ᵢ, as discussed above.

### EXAMPLES

Fabrication of Ink Compositions: Exemplary ink compositions (“inks”) are created by first separately mixing (FlackTek, 120 s at 2000 rpm) the appropriate amount of base and catalyst for two types of PDMS, namely SE 1700 (Dow Corning) with Sylgard 184 (Dow Corning). The neat inks are obtained by combining the resulting pre-mixtures at concentrations of 85% w/w SE 1700 and 15% w/w Sylgard 184, followed by a mixing step (FlackTek, 240 s at 2350 rpm). The filled inks are obtained by combining the SE 1700 and Sylgard 184 pre-mixtures with glass fibers (Fibre Glast, 1/32 inch Glass Fibers, diameter ˜16 μm, length ˜230 μm) at concentrations of 68% w/w SE 1700, 12% w/w Sylgard 184, and 20% w/w glass fibers, followed by a mixing step (FlackTek, 240 sat 2350 rpm). Given the presence of fumed silica in SE 1700 (˜26.5% w/w), the resulting palette of inks contain fumed silica in concentrations ranging from 20% to 22% w/w. As a rheological control, a non-printable mixture (FlackTek, 240 sat 2350 rpm) of 80% w/w Sylgard 184 and 20% w/w of glass fibers is also created. For rheology samples, the crosslinker is replaced with an appropriate concentration of viscosity-matched silicone oils (Sigma Aldrich) to avoid any potential crosslinking effects on the rheological measurements. Notably, the printing process lasts less than ˜90 minutes, much shorter than the 8-hour pot life of the inks. As such, these crosslinking effects do not occur during the printing process. Rheology measurements conducted on the ink compositions show for each a clear plateau modulus, yield stress, and shear thinning response, indicating viscoelasticity. For each ink, the plateau modulus, yield stress, and viscosity exhibit a moderate yet consistent decrease with increasing concentrations of crosslinker. A modest decrease in these parameters is also observed for increasing concentrations of glass fibers.

Fabrication of Printed Lattice: For printing experiments, all ink compositions are loaded into separate 10 cc, Luer-Lok syringes (Nordson, EFD) directly following their synthesis. Upon loading, the inks are then centrifuged (300 s at 3500 rpm for neat inks, and 120 s at 2000 rpm for filled inks) to remove bubbles prior to printing. Each syringe is then mounted to one of four independently controlled z-axes of a multi-axis motion system (ABG 1000, Aerotech Inc.) equipped with a tapered nozzle with a 200 μm inner diameter (Nordson, EFD), and connected to an Ultimus V pressure controller (Nordson, EFD). Custom, open source Python libraries (Mecode) are used to define the print paths of each ink and to coordinate printhead motion with ink extrusion. All samples are printed onto Teflon substrates. Typical pressures and print speeds used are 60 psi and 20 mm/s for the neat inks and 72 psi and 16 mm/s for the filled inks. Generally speaking, a pressure of 50-90 psi and a print speed of 5-50 mm/s may be suitable. For reference, the time it takes to print the lattice for the face, as discussed in reference to FIGS. 6A-6E, is approximately 90 minutes.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A shape-shifting structured lattice comprising:
a printed lattice comprising printed ribs joined at nodes, each printed rib having a predetermined sweep angle \tilde{θ}ᵢ between adjacent nodes and a bilayer structure including at least two printed filaments in contact along a length thereof, the at least two printed filaments comprising different linear coefficients of thermal expansion and/or different values of elastic modulus,
wherein, when exposed to a stimulus, the printed lattice adopts a predetermined three-dimensional geometry.

2. The shape-shifting structured lattice of claim 1, wherein the printed lattice comprises a one-dimensional, a two-dimensional, or a three-dimensional lattice.

3. The shape-shifting structured lattice of claim 1, wherein each printed rib comprises four printed filaments, the bilayer structure being a multiplex bilayer structure comprising a two-by-two stack of the four printed filaments.

4. The shape-shifting structured lattice of claim 1, wherein each printed rib comprises only two printed filaments, each printed rib further comprising a notch.

5. The shape-shifting structured lattice of claim 1, wherein the at least two printed filaments are formed by extrusion through a deposition nozzle from different ink compositions.

6. The shape-shifting structured lattice of claim 1, wherein at least one of the printed filaments comprises anisotropic filler particles.

7. The shape-shifting structure lattice of claim 1, wherein each of the printed filaments comprises a thermosetting polymer.

8. The shape-shifting structured lattice of claim 1, wherein the stimulus is selected from the group consisting of: a change in temperature, a change in pH, a change in humidity, a change in pressure, application of a magnetic field, and application of an electric field.

9. The shape-shifting structured lattice of claim 1, wherein the printed lattice can reversibly shift between the predetermined three-dimensional geometry and an initial printed configuration.

10. A method of fabricating a shape-shifting structured lattice, the method comprising:
conformally mapping a three-dimensional geometry onto a plane to create a planar projection;
discretizing the planar projection to create a grid comprising ribs joined at nodes;
computing a requisite growth factor based on the three-dimensional geometry and determining a corresponding sweep angle \tilde{θ}ᵢ between adjacent nodes for each rib, thereby defining a planar print path;
depositing filaments along the planar print path to form a printed lattice comprising printed ribs joined at the nodes, each printed rib having the sweep angle \tilde{θ}ᵢ and a bilayer structure including at least two printed filaments in contact along a length thereof, the at least two printed filaments comprising different ink compositions;
curing the different ink compositions; and
after the curing, exposing the printed lattice to a stimulus, thereby inducing the printed lattice to adopt the three-dimensional geometry.

11. The method of claim 10, wherein each printed rib comprises four printed filaments arranged in a two-by-two stack, the bilayer structure being a multiplex bilayer structure.

12. The method of claim 10, wherein each printed rib comprises only two printed filaments, each printed rib further comprising a notch.

13. The method of claim 10, wherein the stimulus is selected from the group consisting of: a change in temperature, a change in pH, a change in humidity, a change in pressure, application of a magnetic field, and application of an electric field.

14. The method of claim 10, wherein the curing is effected by exposure to heat, light, and/or a chemical curing agent.

15. The method of claim 10, wherein each of the different ink compositions comprises an uncured polymer, and
wherein the uncured polymer is the same for each of the different ink compositions.

16. The method of claim 15, wherein a crosslinker-to-base ratio is different for at least one of the different ink compositions.

17. The method of claim 10, wherein at least one of the different ink compositions includes anisotropic filler particles.

18. The method of claim 17, wherein the anisotropic filler particles are longitudinally aligned along a print direction.

19. The method of claim 10, wherein, after the curing, the at least two printed filaments comprise different linear coefficients of thermal expansion and/or different values of elastic modulus.

20. The method of claim 10, wherein, prior to depositing the filaments, each filament is extruded from a deposition nozzle.
